(19) United States
(12) Patent Application Publication
(10) Pub. No.: US 2026/0012402 A1
(43) Pub. Date: Jan. 8, 2026

(54) SYSTEM AND METHOD FOR PROVIDING AN IMPROVED SITE ICON DESIGN

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Sundaresh SANKARAN, Mumbai, Maharashtra (IN); Haresh B AMBALIYA, Gujarat (IN); Sandeep RAWAT, Uttarakhand (IN); Abhishek JAIN, Indore, Madhya Pradesh (IN); Mandar PATIL, Navi Mumbai, Maharashtra (IN); Vikram SINGH, Navi Mumbai, Maharashtra (IN)

(73) Assignee: JIO PLATFORMS LIMITED, Ahmedabad, Gujarat (IN)

(21) Appl. No.: 18/993,223

(22) PCT Filed: Jun. 3, 2024
(86) PCT No.: PCT/IN2024/050671

§ 371 Date: Jan. 10, 2025

(30) Foreign Application Priority Data
Jun. 29, 2023 (IN) 202321043824

(51) Int. Cl. H04L 41/22; G06F 3/04817

(52) U.S. Cl. CPC H04L 41/22; G06F 3/04817

(57) ABSTRACT

The disclosed system and method implement a user interface (UI) design for displaying a site icon which provides all key information about cellular sites. The information is related to such as technology, band, number of sectors, number of cells, number of carriers, number of bi-sectors, and the like. In addition, the information is represented with minimum UI elements.

### RESERVATION OF RIGHTS

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to wireless cellular communications, and specifically to a system and a method for providing an improved design of a site icon to be used in a geospatial platform for showing cellular wireless nodes.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

For performing spatial analysis of cellular sites over a map interface, engineers very often need a customized set of icons and spatial tools that are generally not available, and the ones available convey very limited information.

Therefore, there is a need in the art to provide information on cellular sites and information on the map interface that facilitates conveying all crucial information about the cellular sites.

### SUMMARY

In an exemplary embodiment, a method for displaying information of a plurality of cell sites in a network is described. The method comprises obtaining, by a processing unit, information associated with each of the plurality of cell sites of a cluster. The method further comprises processing, by the processing unit (104), the information to generate a plurality of user interface elements representing information corresponding to each of the plurality of the cell sites. The information comprises a plurality of bands, number of sectors, an additional carrier, an additional sector, a plurality of technologies, number of cells, number of carriers, and number of bi-sectors. The method comprises generating, by the processing unit (104), a site icon for each cell site of the plurality of cell sites. Each site icon having the user interface elements representing information corresponding to the cell site. The method comprises displaying, by a display unit, a plurality of site icons of the cell sites on a map interface.

In some embodiment, the method comprises displaying, by the display unit, information associated with the plurality of cell sites according to scaling of the map interface and streamlining, by the display unit, size of the plurality of site icons according to scaling of the map interface.

In some embodiment, the plurality of elements corresponding to the site icons comprises a plurality of minor sectors, the plurality of bands corresponding to plurality of cells, a split sector, additional carrier, technology, wherein each of the minor sector represents a cell.

In some embodiment, each of the cell site is represented by the plurality of minor sectors. The plurality of minor sectors of each cell site is represented by plurality of site-icons with the user interface elements representing information corresponding to the minor sectors.

In some embodiment, site icons corresponding to the plurality of cells of the plurality of bands are displayed by varying radius of the minor sectors. A higher band is represented by small radius and a lowest band is represented by the large radius.

In some embodiment, the split sector is represented by two minor sectors with central angle of 30 degrees. The spacing between the two minor sectors is set to 15 degrees.

In some embodiment, the additional carrier in same band is represented by two minor sectors with a central angle of 30 degrees.

In some embodiment, the plurality of technologies corresponding to the minor sectors is represented by the plurality of representations, wherein the plurality of technologies comprises different generations of mobile network technology.

In another exemplary embodiment, a system for displaying information of a plurality of cell sites in a network is described. A processing unit configured to obtain information associated with each of the plurality of cell sites in a cluster. The processing unit configured to process the information to generate a plurality of user interface elements representing information corresponding to each of the plurality of the cell sites. The information comprises a plurality of bands, number of sectors, an additional carrier, an additional sector, a plurality of technologies, number of cells, number of carriers, and number of bi-sectors. The processing unit configured to generate a site icon for each cell site of the plurality of cell sites, each site icon having the user interface elements representing information corresponding to the cell site. A display unit configured to display a plurality of site icons of the cell sites on a map interface.

The display unit is configured to display the information of the plurality of cell sites according to scaling of the map interface and streamline size of the plurality of site icons according to scaling level of the map interface. In examples, streamlining may refer to adjusting the size of the site icon based on the scaling level of the map. For example, if the map interface is scaled to view a large area, the site icons are minimized to accommodate more site icons of other cells in the map interface view.

In some embodiment, the plurality of elements corresponding to the site icons comprises a plurality of minor sectors, the plurality of bands corresponding to plurality of cells, a split sector, additional carrier, technology, wherein each of the minor sector represents a cell.

In some embodiment, each of the cell site is represented by the plurality of minor sectors. The plurality of minor sectors of each cell site is represented by a plurality of site icons with the user interface elements representing information corresponding to the minor sectors.

In some embodiment, site icons corresponding to the plurality of cells of the plurality of bands are displayed by varying radius of the minor sectors. A higher band is represented by small radius and a lowest band is represented by the large radius.

In some embodiment, the split sector is represented by two minor sectors with central angle of 30 degrees. Spacing between the two minor sectors is set to 15 degrees.

In some embodiment, the additional carrier in same band is represented by two minor sectors with central angle of 30 degrees.

In some embodiment, the plurality of technologies corresponding to the minor sectors is represented by the plurality of representations. The plurality of technologies comprises different generations of mobile network technology.

### OBJECTS OF THE PRESENT DISCLOSURE

It is an object of the present disclosure to provide an improved design of a site icon to be used in any geospatial platform for showing cellular wireless nodes.

It is an object of the present disclosure to provide multiple User Interface (UI) principles which are used for depicting cellular sites for multiple technologies.

It is an object of the present disclosure to display site icons that are not only simple and intuitive but present all crucial information without any additional UI screen.

It is an object of the present disclosure to depict information related to technology, band, sectors, cells, carriers, and bisectors present in the cellular sites.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary network architecture, in accordance with an embodiment of the disclosure.

FIG. 2A illustrates an exemplary multiple minor sectors varying radius representing cells in a different band, in accordance with an embodiment of the disclosure.

FIG. 2B illustrates an exemplary additional sector case, in accordance with an embodiment of the disclosure.

FIG. 3 illustrates an exemplary additional carrier case in highest frequency band in all three directions, in accordance with an embodiment of the disclosure.

FIG. 4 illustrates an exemplary representation of the multiple minor sectors by representations of a circle in a centre, in accordance with an embodiment of the disclosure.

FIG. 5 illustrates an exemplary actual sample site icon, in accordance with an embodiment of the disclosure.

FIG. 6 illustrates multiple exemplary site icon samples in clusters, in accordance with an embodiment of the disclosure.

FIG. 7 illustrates an exemplary sketch of an actual sample site icon, in accordance with an embodiment of the disclosure.

FIG. 8 illustrates a flow chart describing a process of displaying site icon on a map interface, in accordance with an embodiment of the disclosure.

FIG. 9 illustrates an example computer system in which or with which the embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The disclosure provides a User Interface (UI) based design solution for showing a site icon that provides maximum information of a cellular site in an intuitive manner. The proposed disclosure is applicable to 2G, 3G, 4G, 5G, 6G, and beyond, all generations of mobile technology with multiple bands and carriers of telecom operators.

The proposed solution implements the UI design for displaying the site icon which provides all key information about the sites such as related to technology, band, number of sectors, number of cells, number of carriers, number of bi-sectors, and the like. In addition, the information is represented with minimum UI elements.

A digital view of network nodes in the form of a layer over a digital map helps an engineer to perform geospatial analysis. Apart from just showing the location of sites, some other crucial fields are also needed such as band, number of sectors, presence of additional carriers, additional sector, orientation, etc. The orientation information (e.g. azimuth) is obtained from a P2B database of each cell site. The disclosed solution illustrates the UI design scheme where all crucial information about the sites may be shown compactly for various map scales. Further, apart from a site icon design, icon size is also streamlined so that the icon remains intuitive for various scaling levels without causing clutter on the UI.

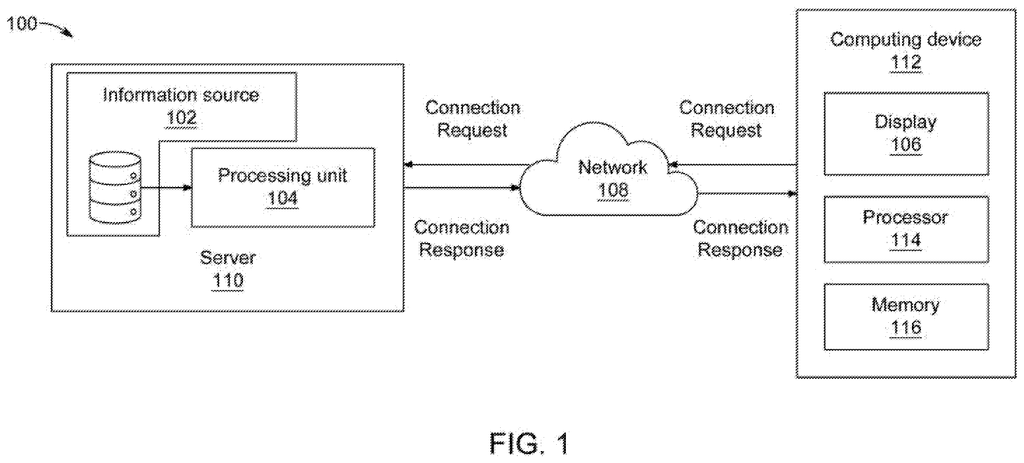

FIG. 1 illustrates an exemplary network architecture (100), in accordance with an embodiment of the present disclosure.

As illustrated in FIG. 1, the network architecture (100) comprises a server (110), a network (108) and a computing device (112). The server (110) may be in communication with the computing device (112) through the network (108). The server (110) comprises an information source (102) and a processing unit (104). The information source (102) may be a master database. The information source (102) may be in communication with the processing unit (104). The information source (102) may provide data to the processing unit (104). The computing device (112) comprises a display (106), a processor (114) and a memory (116).

In an embodiment, the computing device (112) may include, but is not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing device (112) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device (112) may include one or more in-built or externally coupled accessories including, but not limited to, a visual aid device such as a camera, an audio aid, a microphone, a keyboard, and input devices for receiving input from the user or the entity such as touch pad, touch enabled screen, electronic pen, and the like. A person of ordinary skill in the art will appreciate that the computing device (112) may not be restricted to the mentioned devices and various other devices may be used.

In an embodiment, the network (108) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the server (110) may be a computer or system that provides resources, data, services, or programs to other computers over the network. The server (110) is configured to listen to requests from the computing devices over the network.

In an embodiment, the computing device (112) may send a connection request to the server (110). The server (110) may send a response to the connection request. The connection is established between the computing device (112) and the server (110). The computing device (112) may request site information from the server (110). The server (110) may send the site information to the computing device (112). The site information is displayed on the computing device (112) on the display (106) through a user interface (UI). All crucial information corresponding to the site can be shown on the UI for various map scale. The sites can be shown using site icons. Further, size of the site icons is streamlined such that the sites remain intuitive for various zoom level without causing clutter on user interface.

The processor (114) of the computing device (112) may perform processing of the site information before displaying on the user interface of the display (106). The processor (114) may be in communication with the memory (116). The memory (116) of the computing device (112) may store the site information. In operation, the server (110) is communicatively coupled to a computing device (112). The computing device (112) may request for displaying information of a plurality of cell sites in a network. In example, the user may request for a specific area at which the information may be provided. In an aspect, the request may include a viewport area defining location co-ordinates/boundary. The request may also include parameters (e.g., technology, frequency band, etc.). The request received at the server, where it is processed to obtain cell sites from the information source (102) for the requested view port. For the obtained cell sites, parameters are applied to filter the cell sites. And a response (cell sites with cell site information, along with corresponding UI elements) is provided to computing device.

The processing unit (104) is configured to obtain information associated with each of the plurality of cell sites in a cluster. The server (110) may include information source (102) that may have information about the cell sites. The information may include a plurality of frequency bands, a number of sectors, an additional carrier, an additional sector, a plurality of technologies, a number of cells, a number of carriers, and number of bi-sectors. In an aspect, the information source (102) can be a single source or multiple sources, for example 4G source can be different than 5G source, or different vendor source.

The processing unit (104) may process the information to generate a plurality of user interface elements representing information corresponding to each of the plurality of cell sites. In examples, the user interface element may be an icon, pushpin, etc. In the current example, the processing unit (104) may generate a site icon for each cell site of the plurality of cell sites. Each site icon having the user interface elements represents information corresponding to the cell site. The server 110 may communicate the generated site icons along with the user interface elements and map to the computing device (112). The computing device (112) may receive and store the generated site icons along with the user interface elements along with the map in the memory (116). The processor (114) may process the memory (116) to extract and display the generated site icons along with the user interface elements at corresponding locations in the map. The display unit (106) of the computing device (112) is configured to display a plurality of site icons of the cell sites on the map interface. In examples, the display unit (106) is configured to display the information of the plurality of cell sites according to scaling of the map interface. In examples, the display unit (106) is configured to streamline size of the plurality of site icons according to a scaling level of the map interface. The plurality of elements corresponding to the site icons include a plurality of minor sectors, the plurality of bands corresponding to plurality of cells, a split sector, additional carrier, and technology. Each of the minor sector represents a cell.

In examples, each of the cell site is represented by the plurality of minor sectors. The plurality of minor sectors of each cell site is represented by plurality of site-icons with the user interface elements representing information corresponding to the minor sectors. In examples, the site icons corresponding to the plurality of cells of the plurality of bands are displayed by varying radius of the minor sectors, wherein a higher band is represented by a small radius and a lower band is represented by a larger radius. In examples, the split sector is represented by two minor sectors with central angle of 30 degrees, wherein spacing between the two minor sectors is set to 15 degrees.

In some aspect, additional carrier in same band is represented by two minor sectors with central angle of 30 degrees. The plurality of technologies corresponding to the minor sectors is represented by a plurality of representations, wherein the plurality of technologies comprises different generations of mobile network technology.

In an aspect, the request is received at the server, where the request is processed to obtain cell sites from the information source (102) for the requested view port. For the obtained cell sites, parameters are applied to filter the cell sites. And a response (cell sites with cell site information, along with corresponding UI elements) is provided to computing device.

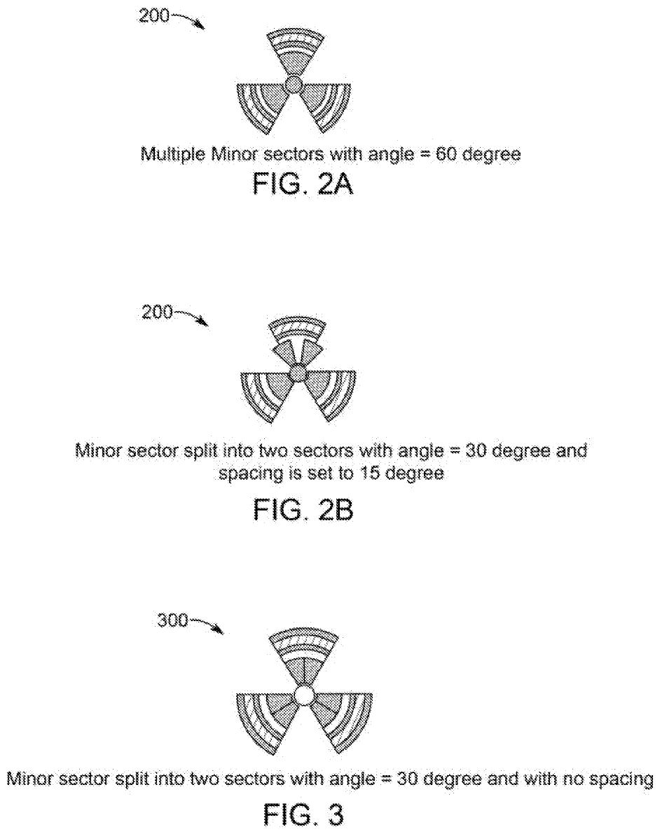

FIG. 2A illustrates an exemplary multiple minor sectors (200) varying radius representing cells in a different band, in accordance with an embodiment of the disclosure.

As illustrated in FIG. 2A, for showing all the crucial information, the following scheme is used. In an aspect, each “minor sector” object represents a telecom network cell with a central angle between them to be 60 degrees. The central angle may vary based on type of antennas. The type of antennas information is obtained from a planning to build (P2B) database. For example, highway serving sites have smaller beam width, typically 30 degrees, and for regular habitat area beam width is 65 degrees. Therefore, depending on the beam width of the antenna, central angle is varied, and representation in the UI of such central angle is varied based on the antenna type.

In aspects, cells of different frequency bands are shown by “minor sector” with different radius. The higher band have smaller radius, while the lower bands have higher radius. As shown, there are multiple bands with different radius from a centre. In the UI, cell site comprises plurality of minor sectors. The plurality of minor sectors of the cell site are connected by a circle. The circle is used to represent technology corresponding to the cell site.

FIG. 2B illustrates an exemplary additional sector case of multiple minor sectors (200), in accordance with an embodiment of the disclosure.

As is illustrated in FIG. 2B, for showing split sector or Bi sector, two “minor sectors” with a central angle of 30 degree each are used, and spacing is set to 15 degrees.

FIG. 3 illustrates an exemplary additional carrier case of multiple minor sectors (300) in the highest frequency band in all three directions, in accordance with an embodiment of the disclosure.

As illustrated in FIG. 3, in case of additional network carriers in the same frequency band, then two ‘minor sectors’ with a central angle set to 30 degrees, are used. There is no angular spacing between minor sectors.

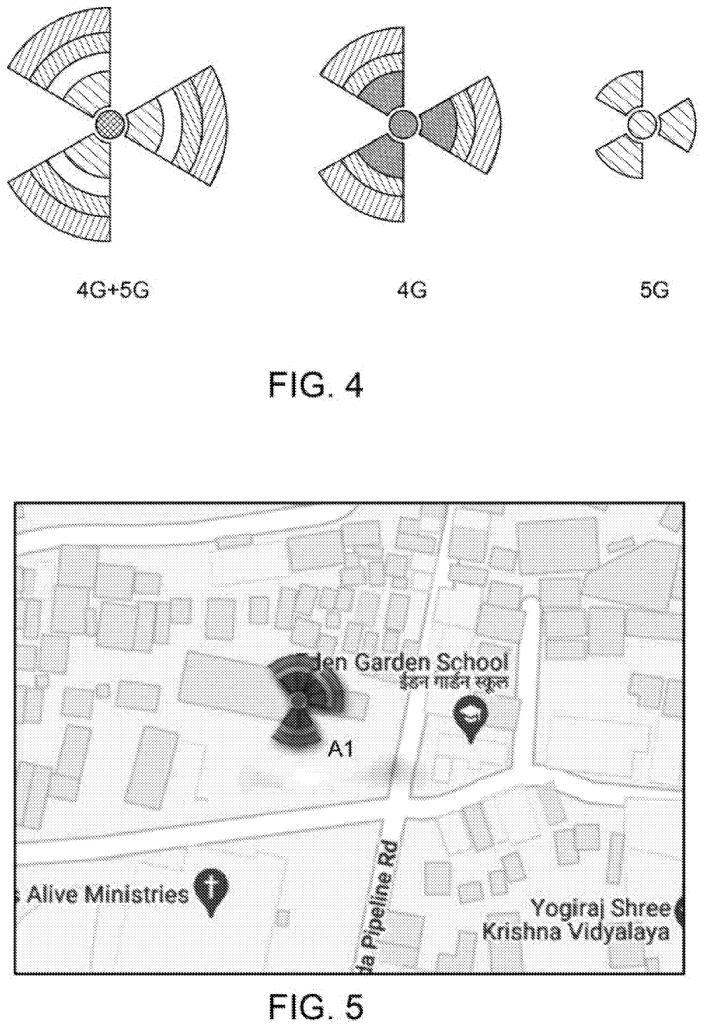

FIG. 4 illustrates an exemplary representation of the multiple minor sectors (400) by representations of a circle in a centre, in accordance with an embodiment of the disclosure.

As illustrated in FIG. 4, the representations of center small circle, which touches all ‘minor sector’ designs, may be used to represent different generations of mobile network technologies (for example, 4G only, 4G and 5G or 5G only). FIG. 4 provides three site icons. The first icon represents a site that supports both 4G and 5G. The second icon represents the site that supports only 4G, and the third icon represents the site that supports only 5G. The disclosed design solution approach may depict technology, band, sectors, cells, carriers, bi-sectors present in the sites.

FIG. 5 illustrates an exemplary actual sample site icon in an interface (500), in accordance with an embodiment of the disclosure.

As is illustrated in FIG. 5, the cell site (e.g., A1) is shown. The cell site comprises 3 set of two minor sectors. Each of the set of two minor sectors comprises additional carriers. The minor sectors are connected by the circle. The circle represents that the cell site uses 4G technology.

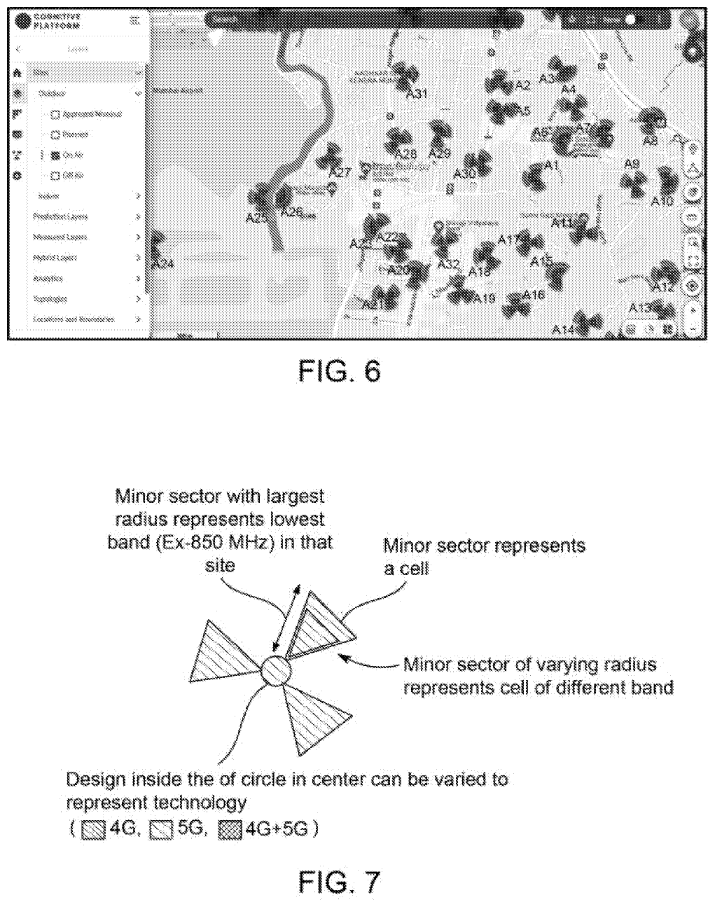

FIG. 6 illustrates multiple exemplary site icon samples in clusters in an interface (600), in accordance with an embodiment of the disclosure.

The user may send a request for displaying information of one of plurality of cell sites in a network to the server (110). The request may comprise of viewport area (e.g., site location co-ordinates/boundary, orientation). The processing unit (104) of server (110) may process the request to get information about the requested cell site corresponding to the viewport area. The UI of the display shows the cell sites with varying orientations (e.g., azimuth) based on the orientation information as shown in map of FIG. 6. As is illustrated in FIG. 6, plurality of cell sites (e.g., A1, A2, A3, A4, A5, A6 . . . . AN, etc.) is represented by the plurality of minor sectors in the interface (600). These site icons represent on air sites as selected by a user.

FIG. 7 illustrates an exemplary sketch of an actual sample site icon (700), in accordance with an embodiment of the disclosure. As is illustrated, a minor sector represents a cell. The minor sector with a largest radius represents a lowest band (e.g., 850 MHz) in that site. Further, the minor sector of varying radius represents cells of a different band. In addition, the design of the circle in the center may be varied to represent different generations of mobile network technologies (for example, 4G, 5G, and 4G+5G).

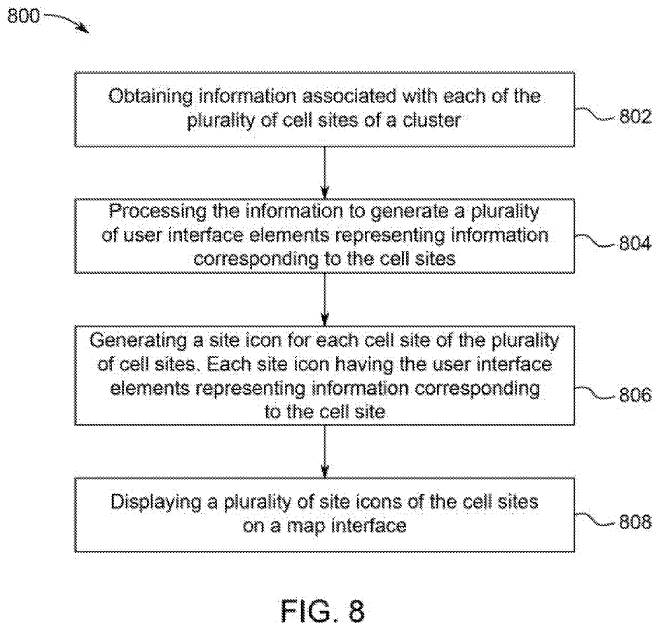

FIG. 8 illustrates a flow chart (800) describing a process of displaying site icons on a map interface in accordance with an embodiment of the disclosure.

As illustrated in FIG. 8, at step 802, obtaining information associated with each of the plurality of cell sites of a cluster.

At step 804, processing the information to generate a plurality of user interface elements representing information corresponding to the cell sites. The information comprises a plurality of bands, number of sectors, additional carrier, additional sector, plurality of technologies, number of cells, number of carriers, and number of bi-sectors.

At step 806, generating a site icon for each cell site of the plurality of cell sites. Each site icon may include the user interface elements representing information corresponding to the cell site.

At step 808, displaying a plurality of site icons of the cell sites on a map interface.

The disclosed design implements the UI design for displaying the site icon which provides all key information about the sites such as the technology, band, number of sectors, number of cells, number of carriers, number of bisectors, and the like.

Further, information representation with minimum UI elements such as minor sector for representing a cell, minor sector belonging to different cells have different radius (i.e., higher the band lower the radius), ability to depict additional carrier, and additional sector using two minor sectors with overlap, and two minor sectors with 15 degrees separation respectively, Technology representation by design of circle object which connect all minor sectors.

The UI design approach for representing the cellular sites may be used as a geospatial tool to make sites map layers for intuitive map layer creation and improved customer experiences. The disclosed design approach lays down the UI principles which may be followed for depicting the cellular sites for multiple technologies. The site icons are not only intuitive but present all the crucial information without any additional UI screen, for example, such as by using a Pop-Up window, and the like.

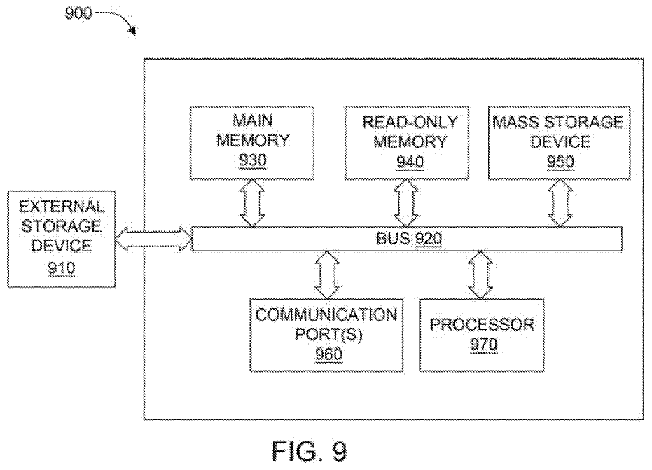

FIG. 9 illustrates an example computer system (900) in which or with which the embodiments of the present disclosure may be implemented.

As shown in FIG. 9, the computer system (900) may include an external storage device (910), a bus (920), a main memory (930), a read-only memory (940), a mass storage device (950), a communication port(s) (960), and a processor (970). A person skilled in the art will appreciate that the computer system (900) may include more than one processor and communication ports. The processor (970) may include various modules associated with embodiments of the present disclosure. The communication port(s) (960) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (960) may be chosen depending on a network, such as a Local Area Network (LAN), Wide Area Network (WAN), or any network to which the computer system connects.

In an embodiment, the main memory (930) may be Random Access Memory (RAM), or any other dynamic storage device commonly known in the art. The read-only memory (940) may be any static storage device(s) e.g., but not limited to, a Programmable Read Only Memory (PROM) chip for storing static information e.g., start-up or basic input/output system (BIOS) instructions for the processor (970). The mass storage device (950) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (920) may communicatively couple the processor(s) (970) with the other memory, storage, and communication blocks. The bus (920) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (970) to the computer system (900).

In another embodiment, operator and administrative interfaces, e.g., a display, keyboard, and cursor control device may also be coupled to the bus (920) to support direct operator interaction with the computer system (900). Other operator and administrative interfaces can be provided through network connections connected through the communication port(s) (960). Components described above are meant only to exemplify various possibilities. In no way should the aforementioned exemplary computer system (900) limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides an improved design of a site icon to be used in any geospatial platform for showing cellular wireless nodes.

The present disclosure provides multiple User Interface (UI) principles which are used for depicting cellular sites for multiple technologies.

The present disclosure displays site icons that are not only simple and intuitive but present all crucial information without any additional UI screen.

The present disclosure depicts information related to technology, frequency band, sectors, cells, carriers, bisectors present in the cellular sites.

1. A method for displaying information of a plurality of cell sites in a network, the method comprising:
obtaining, by a processing unit, information, associated with each of the plurality of cell sites of a cluster;
processing, by the processing unit, the information to generate a plurality of user interface elements representing information corresponding to each of the plurality of cell sites, wherein the information comprises a plurality of bands, number of sectors, an additional carrier, an additional sector, a plurality of technologies, number of cells, number of carriers, and number of bi-sectors;
generating, by the processing unit, a site icon for each cell site of the plurality of cell sites, wherein each site icon is having the user interface elements representing information corresponding to the cell site; and
displaying, by a display unit, a plurality of site icons of the cell sites on a map interface.

2. The method as claimed in claim 1, further comprising:
displaying, by the display unit, the information associated with the plurality of cell sites according to scaling of the map interface; and
streamlining, by the display unit, size of the plurality of site icons according to scaling of the map interface.

3. The method as claimed in claim 1, wherein the plurality of user interface elements corresponding to the site icons comprises a plurality of minor sectors, the plurality of bands corresponding to plurality of cells, a split sector, additional carrier, and technology, wherein each of the minor sector represents a cell.

4. The method as claimed in claim 3, wherein each of the cell site is represented by the plurality of minor sectors, wherein the plurality of minor sectors of each cell site is represented by plurality of site icons with the user interface elements representing information corresponding to the minor sectors.

5. The method as claimed in claim 3, further comprising: displaying the site icons corresponding to the plurality of cells of the plurality of bands by varying radius of the minor sectors, wherein a higher band is represented by small radius and a lower band is represented by a larger radius.

6. The method as claimed in claim 3, wherein the split sector is represented by two minor sectors with central angle of 30 degrees, wherein spacing between the two minor sectors is set to 15 degrees.

7. The method as claimed in claim 3, wherein the additional carrier in same band is represented by two minor sectors with a central angle of 30 degrees.

8. The method as claimed in claim 3, wherein the plurality of technologies corresponding to the minor sectors is represented by a plurality of representations, wherein the plurality of technologies comprises different generations of mobile network technology.

9. A system for displaying information of a plurality of cell sites in a network comprising:
a computing device;
a server communicatively coupled to a computing device and comprising a processing unit configured to:
obtain information associated with each of the plurality of cell sites in a cluster;
process the information to generate a plurality of user interface elements representing information corresponding to each of the plurality of cell sites, wherein the information comprises a plurality of bands, number of sectors, an additional carrier, an additional sector, a plurality of technologies, number of cells, number of carriers, and number of bi-sectors;
generate a site icon for each cell site of the plurality of cell sites, each site icon is having the user interface elements representing information corresponding to the cell site; and
a display unit of the computing device configured to display a plurality of site icons of the cell sites on a map interface.

10. The system claimed as claimed in claim 9, further comprising:
the display unit configured to display the information of the plurality of cell sites according to scaling of the map interface; and
the display unit configured to streamline size of the plurality of site icons according to scaling level of the map interface.

11. The system claimed as claimed in claim 9, wherein the plurality of user interface elements corresponding to the site icons comprises a plurality of minor sectors, the plurality of bands corresponding to plurality of cells, a split sector, additional carrier, and technology, wherein each of the minor sector represents a cell.

12. The system claimed as claimed in claim 11, wherein each of the cell site is represented by the plurality of minor sectors, wherein the plurality of minor sectors of each cell site is represented by plurality of site icons with the user interface elements representing information corresponding to the minor sectors.

13. The system claimed as claimed in claim 11, wherein the site icons corresponding to the plurality of cells of the plurality of bands are displayed by varying radius of the minor sectors, wherein a higher band is represented by a small radius and a lower band is represented by a larger radius.

14. The system claimed as claimed in claim 11, wherein the split sector is represented by two minor sectors with central angle of 30 degrees, wherein spacing between the two minor sectors is set to 15 degrees.

15. The system claimed as claimed in claim 11, wherein the additional carrier in same band is represented by two minor sectors with central angle of 30 degrees.

16. The system claimed as claimed in claim 11, wherein the plurality of technologies corresponding to the minor sectors is represented by a plurality of representations, wherein the plurality of technologies comprises different generations of mobile network technology.

17. (canceled)

18. A computer program product comprising a non-transitory computer-readable medium comprising instructions that, when executed by one or more processors, cause the one or more processors to execute a method for displaying information of a plurality of cell sites in a network, the method comprising:
obtaining, by a processing unit, information associated with each of the plurality of cell sites of a cluster;
processing, by the processing unit, the information to generate a plurality of user interface elements representing information corresponding to each of the plurality of cell sites, wherein the information comprises a plurality of bands, number of sectors, an additional carrier, an additional sector, a plurality of technologies, number of cells, number of carriers, and number of bi-sectors;
generating, by the processing unit, a site icon for each cell site of the plurality of cell sites, wherein each site icon is having the user interface elements representing information corresponding to the cell site; and
displaying, by a display unit, plurality of site icons of the cell sites on a map interface.
